(19) United States
(12) Patent Application Publication
(10) Pub. No.: US 2016/0251064 A1
(43) Pub. Date: Sep. 1, 2016

(54) SHIP PROPULSION PERFORMANCE PREDICTING APPARATUS AND METHOD THEREOF, AND SHIP NAVIGATION ASSISTANCE SYSTEM

(71) Applicant: MITSUBISHI HEAVY INDUSTRIES, LTD., Tokyo (JP)

(72) Inventors: Masahito ISHIOKA, Tokyo (JP); Ryota KUROIWA, Tokyo (JP)

(21) Appl. No.: 14/908,518

(22) PCT Filed: Feb. 5, 2015
(86) PCT No.: PCT/JP2015/053225

§ 371 Date: Jan. 28, 2016

(30) Foreign Application Priority Data
Oct. 17, 2014 (JP) 2014-212794

(51) Int. Cl. B63B 49/00; G08G 3/00

(52) U.S. Cl. CPC B63B 49/00; G08G 3/00

(57) ABSTRACT

A ship propulsion performance predicting apparatus includes: a theoretical propulsion performance computing unit computing theoretical propulsion performance for a desired navigation condition using a physical model of a propulsion system of a target ship; and a corrector correcting the theoretical propulsion performance using the smooth water correction term and the disturbance correction term stored in a correction term database. The smooth water correction term and the disturbance correction term stored in the correction term database are derived by a correction term deriver from operation experience data. The correction term deriver includes: a smooth water correction term deriver deriving the smooth water correction term using the operation experience data and the like under a smooth water condition; and a disturbance correction term deriver using the operation experience data items and the like corresponding to the respective disturbance conditions to compute the disturbance correction term corresponding to the disturbance condition.

### TECHNICAL FIELD

The present invention relates to a ship navigation assistance system and, in particular, to a propulsion performance predicting apparatus and a method thereof.

### BACKGROUND ART

Ship navigation assistance assumes systems in accordance with purposes (e.g., ship performance evaluation, navigation planning, navigation diagnosis, maintenance management system, etc.). A user appropriately and selectively uses the systems, and practically achieves a certain part of the navigation assistance. An integrated system that integrates these individual systems and covers the entire needs related to navigation assistance has not been practically achieved yet. Weather forecasts are not reflected in real time. According to the situation, an appropriate navigation assistance that accommodates change in shipping route environment cannot be provided.

To solve the above problems, for example, PTL 1 proposes a ship navigation assistance system that supports integration of individual systems, and real-time update of weather forecast.

As a technique related to ship navigation assistance, for example, PTL 2 proposes a ship navigation assistance system that predicts and considers the tide speed, and controls the ship speed against water, for the sake of achieving compatibility between on-time operation and energy saving operation.

### CITATION LIST

### Patent Literature

### {PTL 1}

Japanese Unexamined Patent Application, Publication No. 2009-286230

### {PTL 2}

Japanese Unexamined Patent Application, Publication No. 2004-25914

### SUMMARY OF INVENTION

### Technical Problem

For ship navigation assistance, shipping route planning in conformity with a fuel consumption standard in consideration of economy (fuel consumption) is important. Highly reliable shipping route planning requires highly accurate prediction of ship propulsion performance in an actual sea area.

PTL 2 suggests that additional use of mutual link with service experience data allows actual performance of a target ship in an actual sea area to be highly accurately evaluated. Unfortunately, PTL 2 discloses no specific means therefor but only an idea.

The present invention is made in view of such situations, and has an object to provide a ship propulsion performance predicting apparatus and a method therefor, and a ship navigation assistance system which are capable of improving the prediction accuracy of ship propulsion performance in an actual sea area.

### Solution to Problem

A first aspect of the present invention is a ship propulsion performance predicting apparatus, including: a theoretical propulsion performance computing means for computing theoretical propulsion performance for a desired navigation condition using a physical model of a propulsion system of a target ship; a storing means for storing a smooth water correction term and a disturbance correction term which have been derived from operation experience data; a correction means for correcting the theoretical propulsion performance using the smooth water correction term and the disturbance correction term stored in the storing means; and a correction term deriving means for deriving the smooth water correction term and the disturbance correction term stored in the storing means, from the operation experience data, wherein the disturbance correction term is associated with a disturbance condition, and stored in the storing means, the correction term deriving means includes: a smooth water correction term deriving means for deriving propulsion performance in smooth water from the operation experience data under a smooth water condition, and deriving the smooth water correction term from a difference between the propulsion performance in smooth water and the theoretical propulsion performance under the smooth water condition; and a disturbance correction term deriving means for calculating a disturbance propulsion component due to the disturbance condition, using the operation experience data corresponding to the disturbance condition, and the propulsion performance in smooth water, for each of multiple disturbance conditions, and computing the disturbance correction term corresponding to the disturbance condition from a theoretical disturbance propulsion component included in the theoretical propulsion performance under the distribution condition and from the disturbance propulsion component.

This aspect uses the smooth water correction term and the disturbance correction term derived on the basis of the operation experience data obtained in actual navigation to correct the theoretical propulsion performance calculated using the physical model obtained through a tank test and the like. The smooth water correction term and the disturbance correction term are regarded as correction terms for conforming the theoretical propulsion performance to the propulsion performance obtained from the operation experience data obtained in actual navigation. Consequently, correction of the theoretical propulsion performance through use of such a correction term can obtain a propulsion performance close to an actual performance by the prediction, and improve the prediction accuracy.

Furthermore, as to the smooth water correction term and the disturbance correction term, first, the correction term in smooth water is derived, and then the disturbance correction term is derived using the correction term in smooth water. Such separate treatment of the case in smooth water from the case of occurrence of disturbance can obtain highly reliable correction terms.

In the ship propulsion performance predicting apparatus, the disturbance correction term deriving means may divide the operation experience data under the predetermined disturbance condition with respect to a speed into multiple classes, and derive the disturbance correction term for each of the speed classes.

According to the ship propulsion performance predicting apparatus, ship speeds are divided into multiple speed classes, and the disturbance correction terms are derived for each speed class. Consequently, fine correction can be achieved, thereby allowing further improvement in accuracy to be facilitated.

The ship propulsion performance predicting apparatus includes an operation experience database in which the operation experience data is accumulated at any time. The correction term deriving means may repeatedly derive the smooth water correction term and the disturbance correction term at predetermined timing using the operation experience data stored in the operation experience database, and may update the smooth water correction term and the disturbance correction term stored in the storing means.

The ship propulsion performance predicting apparatus derives the smooth water correction term and the disturbance correction term at predetermined timing (e.g., periodically or at navigation planning or the like) using the operation experience data accumulated in the operation experience database at any time, and updates the smooth water correction term and disturbance correction term stored in the storing means. Consequently, at least certain prediction accuracy can be secured without increasing deviation of the prediction accuracy due to the long-term deterioration of the ship and the like.

A second aspect of the present invention is a ship navigation assistance system including the aforementioned ship propulsion performance predicting apparatus.

A third aspect of the present invention is a ship propulsion performance predicting method, including: a correction term deriving step of deriving a smooth water correction term and a disturbance correction term in each disturbance condition from operation experience data; a theoretical propulsion performance computing step of computing theoretical propulsion performance for a desired navigation condition using a physical model of a propulsion system of a target ship; and a correction step of correcting the theoretical propulsion performance using the smooth water correction term and the disturbance correction term which are derived in the correction term deriving step, the correction term deriving step includes: a smooth water correction term deriving step of deriving propulsion performance in smooth water from the operation experience data under a smooth water condition, and deriving the smooth water correction term from a difference between the propulsion performance in smooth water and the theoretical propulsion performance under the smooth water condition; and a disturbance correction term deriving step of calculating a disturbance propulsion component due to the disturbance condition, using the operation experience data corresponding to the disturbance condition, and the propulsion performance in smooth water, for each of multiple disturbance conditions, and computing the disturbance correction term corresponding to the disturbance condition from a theoretical disturbance propulsion component included in the theoretical propulsion performance under the distribution condition and from the disturbance propulsion component.

### Advantageous Effects of Invention

The present invention exerts an advantageous effect of improving the prediction accuracy of ship propulsion performance in an actual sea area.

### BRIEF DESCRIPTION OF DRAWINGS

FIG. 1 is a block diagram showing a schematic configuration of a propulsion performance predicting apparatus according to one embodiment of the present invention.

FIG. 2 is a functional block diagram of the propulsion performance predicting apparatus according to one embodiment of the present invention.

FIG. 3 is a diagram showing an example of theoretical propulsion performance under a smooth water condition.

FIG. 4 is a diagram showing an example of the relationship between ship speed and horsepower obtained from operation experience data stored in a population database.

FIG. 5 is a diagram for illustrating a process performed by a preprocessor for smooth water according to one embodiment of the present invention.

FIG. 6 is a diagram showing an example of propulsion performance in smooth water derived by a smooth water propulsion performance driver.

### DESCRIPTION OF EMBODIMENTS

A ship propulsion performance predicting apparatus (hereinafter, simply referred to as “propulsion performance predicting apparatus”) and a method thereof are hereinafter described with reference to the drawings.

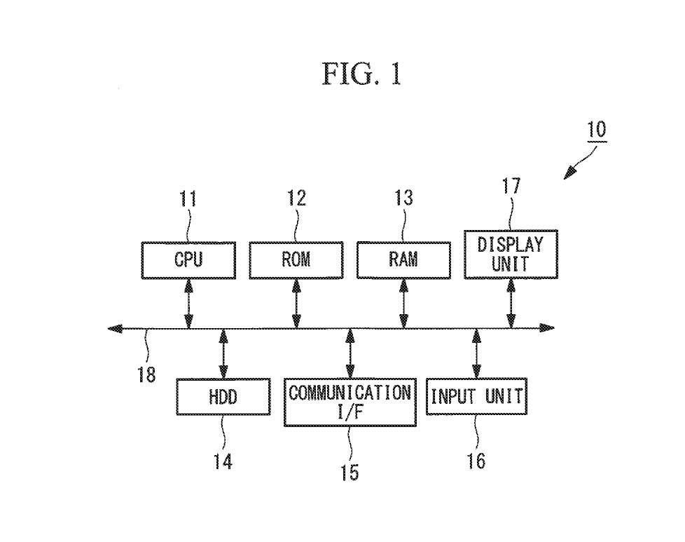

FIG. 1 is a block diagram showing a schematic configuration of a propulsion performance predicting apparatus according to this embodiment. As shown in FIG. 1, a propulsion performance predicting apparatus 10 according to this embodiment is a computer system (computing machine system) and, for example, includes a CPU 11, a ROM (Read Only Memory) 12 for storing programs and the like executed by the CPU 11, a RAM (Random Access Memory) 13 that serves as a work area for execution of each program, a hard disk drive (HDD) 14 that is a mass storage device, a communication interface 15 for connection to a network, an input unit 16 that includes a keyboard and a mouse, and a display unit 17 that includes a liquid crystal display device and displays data. The elements are connected to each other via a bus 18.

The ROM 12 stores programs for achieving configuration elements, which will be described later. The CPU 11 reads the programs from the ROM 12 onto the RAM 13, and executes the programs to thereby achieve various processes.

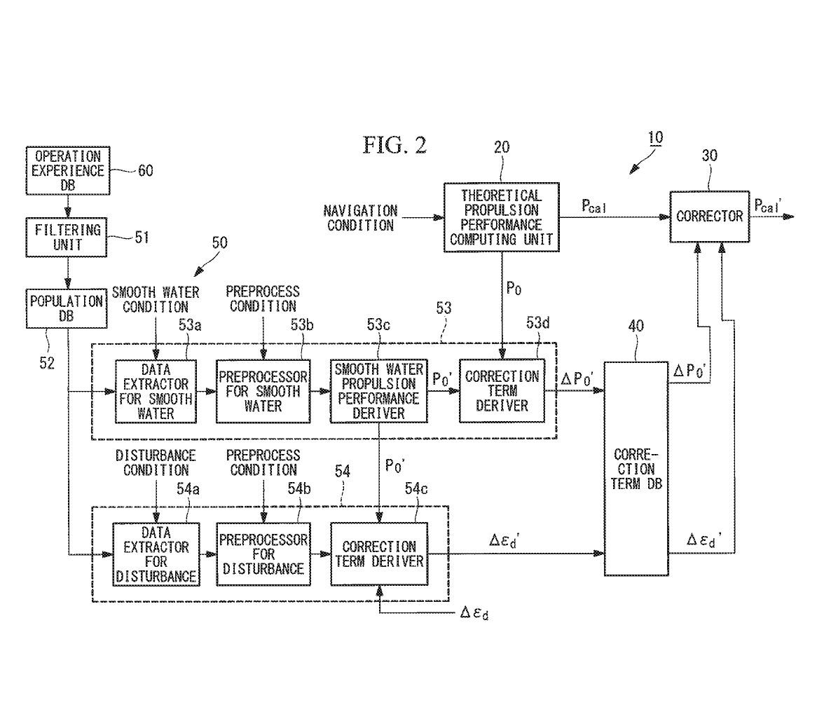

FIG. 2 is a functional block diagram of the propulsion performance predicting apparatus 10. As shown in FIG. 2, the propulsion performance predicting apparatus 10 includes a theoretical propulsion performance computing unit 20, a corrector 30, a correction term database (storing means) 40, and a correction term deriver 50.

The theoretical propulsion performance computing unit 20, for example, computes theoretical propulsion performance under various navigation conditions using a physical model of a propulsion system of a target ship derived by analyzing a result of a tank test using a scaled ship of the target ship. The theoretical propulsion performance is information that represents the relationship between a ship and the propulsive output power, and represented in, for example, a ship speed (kn)—horsepower (kW) curve, a ship speed (kn)—power consumption curve and the like. For convenience of description, the following description is made exemplifying a ship speed-horsepower curve as the propulsion performance.

The theoretical propulsion performance is, for example, computed by providing the physical model of the ship propulsion system with predetermined input information related to navigation condition, such as a disturbance condition, ship speed, and navigation state (ship attitude).

The disturbance conditions are conditions of factors, such as weather (wind speed etc.) and oceanic phenomena (tide speed, current, wave height, etc.), which affect ship navigation. The physical model is, for example, expressed by the following Equation (1). The following description is made using horsepower as the propulsive output power. However, the technique is not limited to this example.

P_{cal}=P₀+ε_{d} (1)

In Equation (1), P_{cal} is the horsepower (kW) under a predetermined navigation condition. P₀ is the horsepower (kW) under a smooth water condition. ε_{d} is a theoretical disturbance term, i.e., the horsepower (kW) caused by an effect of a disturbance factor under a predetermined navigation condition, and ε_{d}=0 under a smooth water condition.

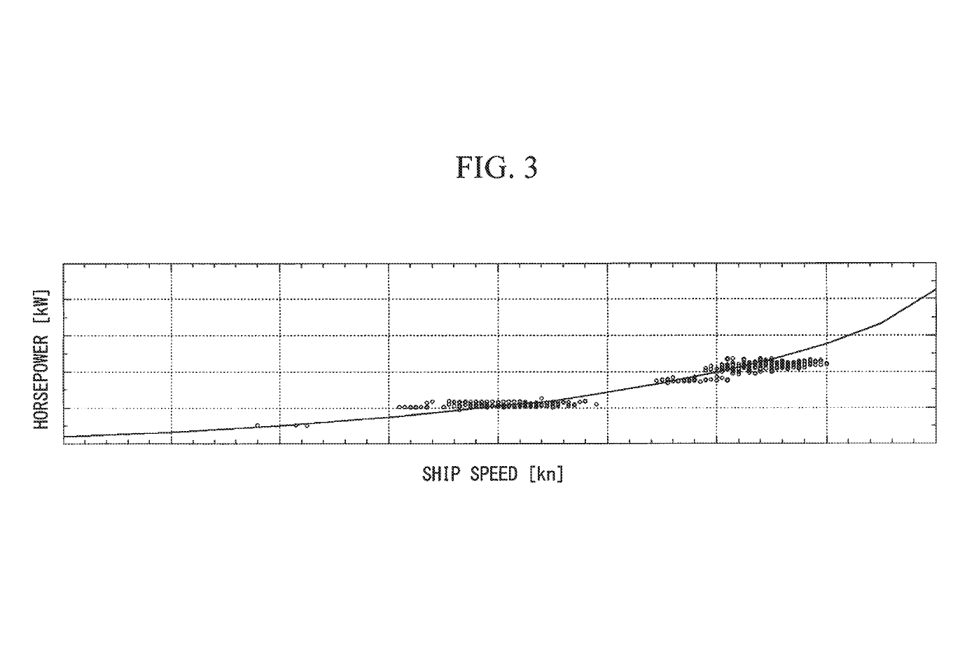

FIG. 3 shows an example of theoretical propulsion performance under a smooth water condition. In FIG. 3, the abscissa indicates the ship speed (kn), and the ordinate indicates the horsepower (kW).

The corrector 30 corrects the theoretical propulsion performance, using a smooth water correction term stored in the correction term database 40, and a disturbance correction term associated with each disturbance condition.

More specifically, the theoretical propulsion performance is corrected using the following Equation (2).

P_{cal}′=P_{cal}+ΔP₀′+Δε_{d}′=(P₀+ΔP₀′)+(ε_{d}+Δε_{d}′) (2)

In Equation (2), P_{cal}′ is the horsepower (kW) after being corrected under a predetermined navigation condition. ΔP₀′ is the smooth water correction term. Δε_{d}′ is a disturbance correction term under a predetermined disturbance condition.

Here, the smooth water correction term stored in the correction term database 40, and the disturbance correction term associated with each disturbance condition are correction terms derived from ship operation experience data in an actual sea area, and is information preliminarily calculated by a following correction term deriver 50 and stored.

Thus, the theoretical propulsion performance is corrected using the smooth water correction term and the disturbance correction term which have been derived from the operation experience data. Consequently, insufficient prediction accuracy in an actual sea area by the physical model using the result of the tank test can be compensated with the correction terms.

The correction term deriver 50 derives the smooth water correction term and the disturbance correction term from the operation experience data stored in the operation experience database 60.

In the operation experience database 60, the operation experience data through actual navigation of the target ship is accumulated. The operation experience data includes, for example, a data item for navigation and a data item for engines. In one example, data on the position of ship, oceanic phenomena, weather, speed, horsepower, the number of revolution of propellers and the like is associated with temporal (date and time) information and stored. The operation experience data have been sampled in real time during navigation of the target ship and accumulated. As to information on weather and oceanic phenomena, instead of information detected by the ship, data obtained from an external information center that distributes the information on weather and oceanic phenomena may be used.

The correction term deriver 50 includes a filtering unit 51, a population database 52, a smooth water correction term deriver 53, and a disturbance correction term deriver 54.

The filtering unit 51 filters out operation experience data items during unstable navigation, such as a data item during anchoring and a data item sampled around a port, from the entire operation experience data stored in the operation experience database 60. Thus, the operation experience data items that may serve as noise can be eliminated from the population for obtaining the correction terms. This elimination can improve the accuracy of calculating the correction terms. The filtered-out operation experience data is stored in the population database 52. FIG. 4 shows an example of the relationship between ship speed and horsepower obtained from operation experience data stored in the population database 52.

The smooth water correction term deriver 53 includes a data extractor for smooth water 53a, a preprocessor for smooth water 53b, a smooth water propulsion performance deriver 53c, and a correction term deriver 53d.

The data extractor for smooth water 53a extracts the operation experience data items that satisfy the smooth water condition, that is, the operation experience data items obtained under the smooth water condition, from the population database 52, and outputs the extracted data items to the preprocessor for smooth water 53b.

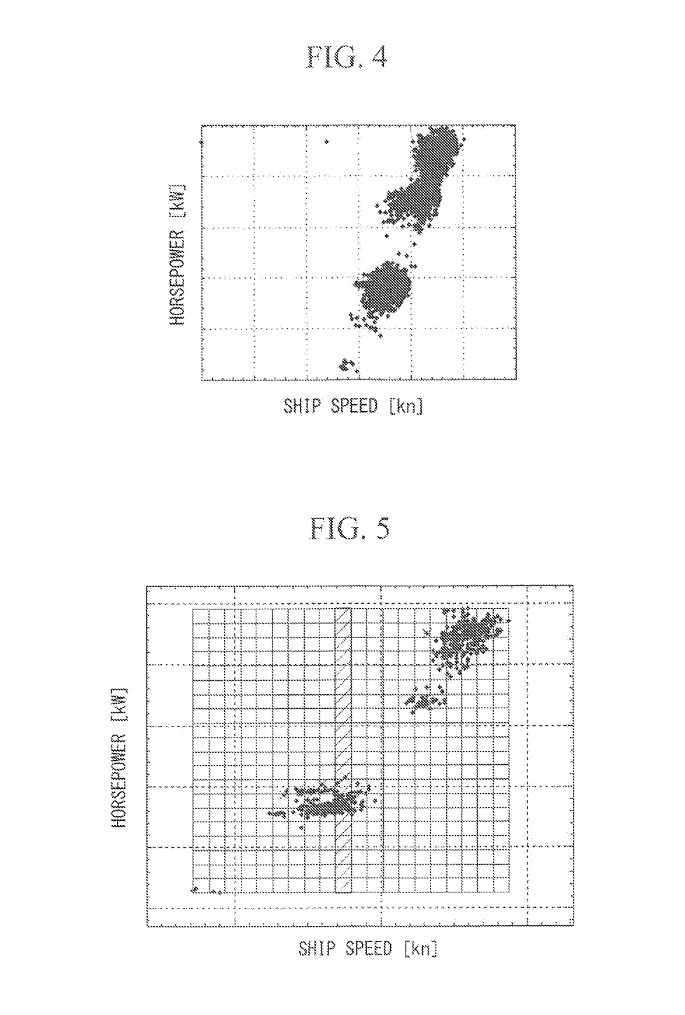

The preprocessor for smooth water 53b calculates the standard deviation of the operation experience data items input from the data extractor for smooth water 53a, and eliminates the operation experience data items with the standard deviation deviating by at least 3σ as outliners. Subsequently, the preprocessor for smooth water 53b divides the operation experience data items into multiple speed classes (bin division) with respect to the speed. At this time, the number of divisions of speed, or the speed width of one speed section is, for example, defined according to the preprocess condition input from the input unit 16 (see FIG. 1). More specifically, as shown in FIG. 5, the preprocessor for smooth water 53b plots points identified by the operation experience data on xy coordinates where the x axis indicates the speed and the y axis indicates the horsepower, and divides both the coordinate axes on the basis of the preprocess condition (the mesh size, and the number of divisions (n rows and k columns)) input from the input unit 16 to thereby form a mesh (bin division), and outputs the information to the smooth water propulsion performance deriver 53c.

The smooth water propulsion performance deriver 53c derives the propulsion performance in smooth water using the operation experience data preprocessed by the preprocessor for smooth water 53b. For example, the smooth water propulsion performance deriver 53c obtains the speed-horsepower curve under the smooth water condition using statistical and approximation methods for each speed class. More specifically, an identification number i (i=1 to k) is assigned to each column (e.g., unit of a hatched strip shown in FIG. 5), i.e., each speed class, in the mesh input from the preprocessor for smooth water 53b. Subsequently, in each speed class, the average of ship speeds and the average of horsepowers of data (points) contained in the speed class are calculated, and the point identified by the average values is regarded as the representative coordinates of this speed class. Here, the representative coordinates with i=1 can be represented as (x1, y1).

Accordingly, the representative coordinates are obtained for all the speed classes, i.e., the respective speed classes having the identification numbers i=1 to k, in a one-by-one basis. Total k sets of representative coordinates are thus obtained at the maximum. Speed classes without data are left to be with no representative point.

Subsequently, approximation is performed using the representative coordinates in each speed class. For example, the approximation may be performed by connecting the representative coordinates of the speed classes adjoining each other by a straight line. Here, characteristics among the representative coordinates adjoining each other are represented by a linear function y=ax+b (y=horsepower, x=ship speed). Thus, for example, in the case with k sets of representative coordinates, the propulsion performance is represented as a function where k−1 linear functions are connected. In the speed class with no representative coordinates, the representative coordinates can be interpolated from the sets of representative coordinates adjoining this speed section concerned.

More specifically, the coefficients ai and bi of the linear function connecting the two points i and i+1 can be acquired by the determinant represented by the following Equation (3). The k−1 linear functions can be obtained by repeating this acquisition from i=1 to k.

$$( \begin{matrix}{y}_{i} \\ {y}_{i + 1}\end{matrix} ) = ( \begin{matrix}{x}_{i} & 1 \\ {x}_{i + 1} & 1\end{matrix} ) ( \begin{matrix}{a}_{i} \\ {b}_{i}\end{matrix} ) \qquad ( 3 )$$

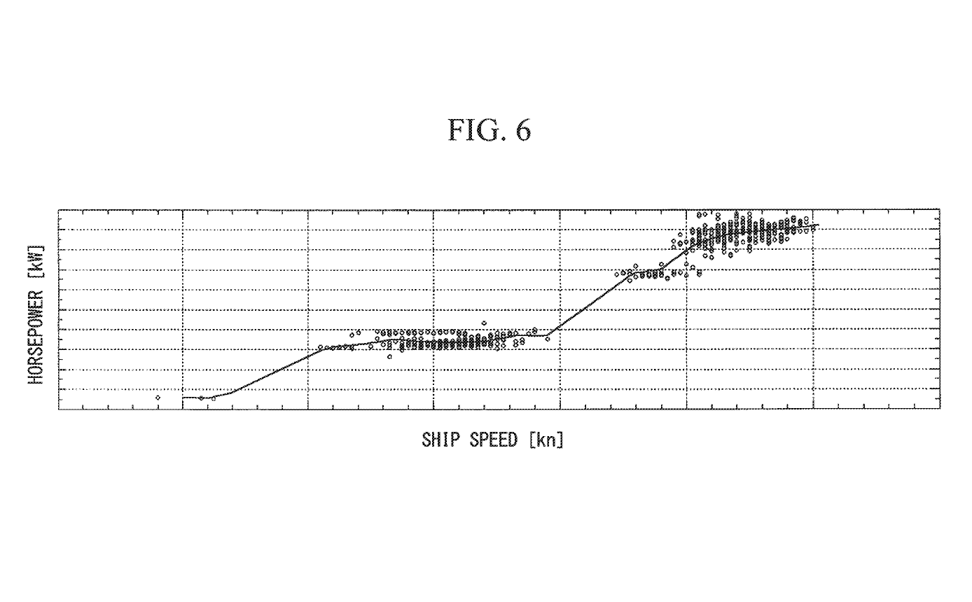

FIG. 6 shows an example of propulsion performance in smooth water derived by the smooth water propulsion performance deriver 53c.

The correction term deriver 53d calculates the smooth water correction term from the difference between the propulsion performance in smooth water derived by the smooth water propulsion performance deriver 53c and the theoretical propulsion performance under the smooth water condition obtained by the theoretical propulsion performance computing unit 20. The smooth water correction term ΔP₀′ is obtained by the following Equation (4).

ΔP₀′=P₀−P₀′ (4)

In Equation (4), ΔP₀′ is the smooth water correction term, P₀ is the horsepower in smooth water (kW) obtained from the theoretical propulsion performance, P₀′ is the horsepower (kW) obtained from the propulsion performance in smooth water derived by the smooth water propulsion performance deriver 53c. Here, the ΔP₀′, P₀ and P₀′ may be represented in a horsepower at a predetermined ship speed, or represented in a function adopting a speed as a variable.

Thus, the value obtained by subtracting the ship speed-horsepower curve shown in FIG. 3 from the ship speed-horsepower curve shown in FIG. 6 serves as the smooth water correction term.

The smooth water correction term ΔP₀′ calculated by the correction term deriver 53d is stored in the correction term database 40.

The disturbance correction term deriver 54 includes a data extractor for disturbance 54a, a preprocessor for disturbance 54b, and a correction term deriver 54c.

The data extractor for disturbance 54a extracts the operation experience data items that satisfy a predetermined disturbance condition input through the input unit 16 (see FIG. 1) from the population database 52, and outputs the extracted data items to the preprocessor for disturbance 54b.

The preprocessor for disturbance 54b calculates the standard deviation of the operation experience data items input from the data extractor for disturbance 54a, and eliminates the operation experience data items with the standard deviation deviating by at least 3σ. Subsequently, as with the aforementioned preprocessor for smooth water 53b, as shown in FIG. 5, the preprocessor for disturbance 54b plots points identified by the operation experience data on xy coordinates where the x axis indicates the speed and the y axis indicates the horsepower, and divides both the coordinate axes on the basis of the preprocess condition (the mesh size, and the number of divisions (n rows and k columns)) input from the input unit 16 to thereby form a mesh, and outputs the information to the correction term deriver 54c.

The correction term deriver 54c calculates the disturbance correction term using the preprocessed operation experience data input from the preprocessor for disturbance 54b, and the propulsion performance in smooth water (see FIG. 6) derived by the smooth water propulsion performance deriver 53c.

More specifically, the correction term deriver 54c calculates the disturbance term for each column (e.g., unit of a hatched strip shown in FIG. 5), i.e., each speed class, in the mesh. Here, it is assumed that the theoretical disturbance term ε_{d} in Equation (1) includes four disturbance factors ε₁ to ε₄. In this case, the disturbance term (disturbance propulsion component) in an actual sea area obtained from the operation experience data is represented in Equation (5).

ε_{d}(k,j)′=α(k)ε_{1,j=1}(k)+β(k)ε_{2,j=1}(k)+γ(k)ε_{3,j=1}(k)+ζ(k)ε_{4,j=1}(k) (5)

In Equation (5), k indicates the speed class at i=k, j is an identification number of each data belonging to each speed class. For example, the m-th data in the speed class at i=k is represented as k (j=m). α, β, γ and ζ are correction coefficients corresponding to respective disturbance factors ε₁ to ε₄.

For example, the disturbance term ε_{d}(k)′ in the speed class at i=k is calculated by the following Equation (6).

$$\begin{matrix}{{ɛ}_{d} ( k , j )}^{′} = {P ( k )}^{′} - {{P}_{0} ( k )}^{′} & ( 6 ) \\ {P ( k )}^{′} - {{P}_{0} ( k )}^{′} = [ \begin{matrix}{ɛ}_{1 , 1} ( k ) & {ɛ}_{2 , 1} ( k ) & {ɛ}_{3 , 1} ( k ) & {ɛ}_{4 , 1} ( k ) \\ ⋮ & ⋮ & ⋮ & ⋮ \\ {ɛ}_{1 , m} ( k ) & {ɛ}_{2 , m} ( k ) & {ɛ}_{3 , m} ( k ) & {ɛ}_{4 , m} ( k )\end{matrix} ] [ \begin{matrix}α ( k ) \\ β ( k ) \\ γ ( k ) \\ ζ ( k )\end{matrix} ] \\ min \vert \vert {ɛ}_{1 \to 4 , 1 \to m} \times ( α , β , γ , ζ ) \vert \vert & ( 7 )\end{matrix}$$

In Equation (7), m is the total number of data items belonging to the speed class at =k. For example, in the case where 20 data items are in the speed class (i=k), m=20. The matrices on the right side and the left side are matrices each having 20 rows and 4 columns. The correction term deriver 54c applies a Moore Penrose pseudo-inverse matrix to Equation (7), and calculates the optimal solutions of α(k), ρ(k), γ(k) and ζ(k) that have norm minimum values.

Here, in Equation (7), in order to obtain α(k), β(k), γ(k) and ζ(k), the same number (m) of operation experience data items P₀(k)′ under the smooth water condition in the speed class at i=k is also required. These data items may be obtained as m y values (horsepower) by providing the m x values (ship speed) belonging to the speed class for the propulsion performance in smooth water (speed-horsepower curve) derived by the smooth water propulsion performance deriver 53c.

After the correction coefficients α(k), β(k), γ(k) and ζ(k) are obtained, the correction term deriver 54c calculates the disturbance correction term in the speed class at i=k according to the following Equation (8).

Δε_{d}(k)′=ε_{d}(k,j)′−ε_{d}(k,j) (8)

Here, as represented in the following Equation (9), ε_{d}(k,j) is the theoretical disturbance term belonging to the speed class at i=k obtained by the theoretical propulsion performance computing unit 20 among the theoretical disturbance terms obtained when the disturbance condition is input into the physical model.

ε_{d}(k,j)=ε_{1,j=1}(k)+ε_{2,j=1}(k)ε_{3,j=1}(k)+ε_{4,j=1}(k) (9)

After the disturbance correction term Δε_{d}(i,j)′ according to the number m of data items is thus obtained in each speed class, the disturbance correction term is associated with each speed class (i=1 to k) and the disturbance condition, and stored in the correction term database 40.

Various disturbance conditions are then input from the input unit 16. This input allows the disturbance correction terms in conformity with the various disturbance conditions to be computed in the respective speed classes according to the aforementioned procedures. These terms are accumulated in the correction term database 40.

Next, the propulsion performance prediction by the propulsion performance predicting apparatus 10 including the aforementioned configuration is described.

First, after the set ship speed, the disturbance condition, and the navigation condition are input in consideration of the target ship, the theoretical propulsion performance (P_{cal}) by means of the physical model of the ship propulsion system is computed by the theoretical propulsion performance computing unit 20. The computed result is output to the corrector 30.

The corrector 30 obtains the smooth water correction term ΔP₀′ and the disturbance correction term Δε_{d}′ in conformity with the disturbance condition and the set ship speed from the correction term database 40, and corrects the theoretical propulsion performance using the obtained smooth water correction term ΔP₀′ and the disturbance correction term Δε_{d}′ according to the following Equation (10).

P_{cal}′=P₀+ΔP₀′+ε_{d}+Δε_{d}′ (10)

The corrected propulsion performance is input into a shipping route planning system, not shown, connected to the propulsion performance predicting apparatus 10, and used for shipping route planning for a ship.

As described above, the propulsion performance predicting apparatus 10 and the method thereof according to this embodiment correct the theoretical propulsion performance calculated using the physical model obtained by a tank test and the like, through use of the smooth water correction term and the disturbance correction term derived on the basis of the operation experience data obtained in actual navigation. The correction can improve the prediction accuracy of the propulsion performance.

The propulsion performance predicting apparatus and the method thereof according to this embodiment first derives the correction term in smooth water, and then derives the disturbance correction term using the correction term in smooth water. Such separate treatment of the case in smooth water from the case of occurrence of disturbance can obtain the highly reliable correction term.

Furthermore, ship speeds are divided into multiple speed classes. The disturbance correction terms are derived for each speed class, more specifically, for each data item. Consequently, fine correction can be achieved, thereby allowing further improvement in accuracy to be facilitated.

In this embodiment, the operation experience data is divided into multiple speed classes, the disturbance correction term and the like are derived for each speed class. The technique is not limited to this example. Alternatively, for example, the propulsion performance under the disturbance condition may be derived from the operation experience data extracted by the data extractor for disturbance 54a. The disturbance correction term may be derived using characteristics obtained by subtracting the propulsion performance in smooth water from the propulsion performance under the disturbance condition.

In the propulsion performance predicting apparatus 10 according to this embodiment, the operation experience data is successively accumulated in the operation experience database 60. Consequently, the correction term deriver 50 may derive the smooth water correction term and the disturbance correction term using the operation experience data accumulated in the operation experience database 60 at predetermined timing (e.g., periodically or at navigation planning or the like), and update the various correction terms stored in the correction term database 40. The smooth water correction term and the disturbance correction term are thus updated at any time, thereby allowing at least certain prediction accuracy of the propulsion performance to be secured without increasing deviation of the prediction accuracy due to long-term deterioration of the ship and the like.

The propulsion performance predicting apparatus according to this embodiment is preferably applied to a ship navigation assistance system. This apparatus is also applicable to an integrated system that integrates not only navigation planning but also maintenance and management functions and the like, and supports all the needs related to the navigation assistance.

As described above, the propulsion performance predicting apparatus 10 according to this embodiment can predict propulsion capability at higher accuracy than that in conventional cases. Consequently, reflection of this propulsion capability prediction to shipping route planning allows highly reliable navigation planning to be achieved. For example, since there is a correlation between the horsepower and the power consumption, the power consumption and the like in actual navigation can be predicted at high accuracy. Consequently, appropriate navigation planning can be achieved in an economic viewpoint.

Furthermore, the smooth water correction term and the disturbance correction term in the correction term database 40 are periodically updated by the correction term deriver 50. This update can achieve correction through use of the correction term that reflects the current state of the target ship. Consequently, long-term accuracy compensation can be provided for a user, thereby allowing reliability to be achieved in a quality aspect.

Analysis of the update history of the correction term database 40 allows the long-term trend, such as long-term deterioration of a ship, to be grasped. Consequently, appropriate repair timing can be determined, which can contribute to maintenance and checkups.

The present invention is not limited to the aforementioned embodiments. Various implementation can be made in a modified manner without departing from the scope of the invention.

### REFERENCE SIGNS LIST

10 Ship propulsion performance predicting apparatus
20 Theoretical propulsion performance computing unit
30 Corrector
40 Correction term database
50 Correction term deriver
51 Filtering unit
52 Population database
53 Smooth water correction term deriver
53a Data extractor for smooth water
53b Preprocessor for smooth water
53c Smooth water propulsion performance deriver
53d, 54c Correction term deriver
54 Disturbance correction term deriver
54a Data extractor for disturbance
54b Preprocessor for disturbance
60 Operation experience database

1. A ship propulsion performance predicting apparatus, comprising:
a theoretical propulsion performance computing means for computing theoretical propulsion performance for a desired navigation condition using a physical model of a propulsion system of a target ship;
a storing means for storing a smooth water correction term and a disturbance correction term which have been derived from operation experience data;
a correction means for correcting the theoretical propulsion performance using the smooth water correction term and the disturbance correction term stored in the storing means; and
a correction term deriving means for deriving the smooth water correction term and the disturbance correction term stored in the storing means, from the operation experience data,
wherein the disturbance correction term is associated with a disturbance condition, and stored in the storing means,
the correction term deriving means comprises:
a smooth water correction term deriving means for deriving propulsion performance in smooth water from the operation experience data under a smooth water condition, and deriving the smooth water correction term from a difference between the propulsion performance in smooth water and the theoretical propulsion performance under the smooth water condition; and
a disturbance correction term deriving means for calculating a disturbance propulsion component due to the disturbance condition, using the operation experience data corresponding to the disturbance condition, and the propulsion performance in smooth water, for each of multiple disturbance conditions, and computing the disturbance correction term corresponding to the disturbance condition from a theoretical disturbance propulsion component included in the theoretical propulsion performance under the distribution condition and from the disturbance propulsion component.

2. The ship propulsion performance predicting apparatus according to claim 1,
wherein the disturbance correction term deriving means divides the operation experience data under the predetermined disturbance condition with respect to a speed into multiple classes, and derives the disturbance correction term for each of the speed classes.

3. The ship propulsion performance predicting apparatus according to claim 1, further comprising
an operation experience database in which the operation experience data is accumulated at any time,
wherein the correction term deriving means repeatedly derives the smooth water correction term and the disturbance correction term at predetermined timing using the operation experience data stored in the operation experience database, and updates the smooth water correction term and the disturbance correction term stored in the storing means.

4. A ship navigation assistance system, comprising the ship propulsion performance predicting apparatus according to claim 1.

5. A ship propulsion performance predicting method, comprising:
a correction term deriving step of deriving a smooth water correction term and a disturbance correction term in each disturbance condition from operation experience data;
a theoretical propulsion performance computing step of computing theoretical propulsion performance for a desired navigation condition using a physical model of a propulsion system of a target ship; and
a correction step of correcting the theoretical propulsion performance using the smooth water correction term and the disturbance correction term which are derived in the correction term deriving step,
wherein the correction term deriving step comprises:
a smooth water correction term deriving step of deriving propulsion performance in smooth water from the operation experience data under a smooth water condition, and deriving the smooth water correction term from a difference between the propulsion performance in smooth water and the theoretical propulsion performance under the smooth water condition; and
a disturbance correction term deriving step of calculating a disturbance propulsion component due to the disturbance condition, using the operation experience data corresponding to the disturbance condition, and the propulsion performance in smooth water, for each of multiple disturbance conditions, and computing the disturbance correction term corresponding to the disturbance condition from a theoretical disturbance propulsion component included in the theoretical propulsion performance under the distribution condition and from the disturbance propulsion component.
